(19) United States
(12) Patent Application Publication
(10) Pub. No.: US 2010/0273375 A1
(43) Pub. Date: Oct. 28, 2010

(54) AQUEOUS SIZING FOR PRODUCING GLASS FIBRE PRODUCTS

(75) Inventors: Roman Teschner, Delitzsch (DE); Kati Richter, Delitzsch/OT Pohritzsch (DE); Hans-Peter Richter, Delitzsch/OT Pohritzsch (DE)

Correspondence Address: LERNER GREENBERG STEMER LLP, P O BOX 2480, HOLLYWOOD, FL, 33022-2480, US

(73) Assignee: S.D.R. BIOTEC VERFAHRENSTECHNIK GMBH, Neukyhna (DE)

(21) Appl. No.: 12/682,621

(22) PCT Filed: Oct. 7, 2008
(86) PCT No.: PCT/EP08/08433

§ 371 Date: Apr. 12, 2010

(30) Foreign Application Priority Data
Oct. 12, 2007 (DE) 10 2007 049 240.7

(51) Int. Cl. B32B 17/10; C08K 5/09; C08K 5/541; C08K 5/1515; B05D 3/02; B32B 5/02

(52) U.S. Cl. 442/1; 524/300; 524/264; 524/114; 524/262; 427/385.5; 428/392; 442/108

(57) ABSTRACT

An aqueous sizing is provided for treating glass fibers, in particular for producing roving fibers, glass staple fibers and cut reinforcing fibers in a thermally and chemically resistant glass, and also to glass fibers coated with the sizing. The sizing protects the glass fibers against scuffing and thus from mechanical damage.

The present invention relates to an aqueous sizing, also referred to as a fiber spin finish, for treating glass fibers, more particularly for producing roving fibers, glass staple fibers and chopped reinforcing fibers from a thermally and chemically resistant glass, and also to glass fibers coated with the sizing of the present invention.

Glass fibers are vulnerable to kinking and scuffing, irrespective of their chemical composition.

Therefore, even as the fibers are being formed by pulling, sizing has to be applied to protect the glass fibers against the scuffing action of glass on glass and/or of glass on pulling drum and thus from the risk of mechanical damage. This is accomplished by applying a sizing.

The composition of the sizing influences not just the compactness, stiffness, hardness and surface qualities of the glass-fiber products but also the technological operations, for example fiber pulling, winding (package build), drying and, more particularly, the further processability (weaving, cutting) of textile glass fibers.

In weaving, it is the cuttability and antislippage resistance of the warp and weft threads as well as the friction and damage of the glass filaments (fiber fly, broken ends) which are dependent on the composition of the sizing.

Sizings of this kind are known in the form of textile-product sizings, comprising starch, and as plastic-reinforcement sizings, comprising bonding agents. The starch-containing sizings, in contradistinction to the plastic-reinforcement sizings, usually do not contain an adhesion promoter.

The aqueous sizings for textile glass fibers consist predominantly of one or more film formers, a lubricant, a wetting agent and one or more adhesion promoters (coupling agents, primers).

A film former endows the textile glass products with the requisite integrity, protects glass filaments from mutual friction and contributes to the affinity for the binder or plastic matrix and hence to the strength of the end product (a composite material for example). Film formers used are starch derivatives, polymers and copolymers of vinyl acetate of acrylic esters, epoxy resin emulsions, epoxy polyester resins [EP-A-0 027 942], polyurethane resins, polyolefin resins or mixed emulsions of polyvinyl acetate and polystyrene [Jap. Pat. SHO-48 (1973)-28997] in a proportion of 0.1 to 12 mass percent (% by mass=% by weight).

A lubricant in aqueous sizings endows the glass-fiber product (such as a roving for example) with the necessary suppleness and reduces the mutual friction of the glass fibers not only during production but also during further processing, for example weaving.

Most lubricants impair the adherence between the glass and the binder. Lubricants used are for example fats, oils, waxes, polyalkyleneamines in an amount of 0.01% to 1.0% by mass.

A wetting agent as a component of an aqueous sizing reduces the surface tension of water and hence improves the wetting of the filaments with the sizing.

Wetting agents are introduced into the aqueous sizing, for example poly(fatty acid amide)s in an amount of 0.1% to 1.5% by mass.

Most resins (polymers) have no affinity for glass. Bonding agents (primers) create a “bridge” between the glass and the resin, ensuring complete transmission of force within the composite. Adhesion promoters promote the adhesion of polymers to the glass surface. The bonding agents used are usually organofunctional silanes, for example γ-aminopropyltriethoxysilane, γ-methacryloyloxypropyltrimethoxysilane, γ-glycidyloxypropyltrimethoxysilane and others, the amount of which in the sizing is 0.2% to 1.0% by mass.

Before silanes are added to the aqueous sizing, they are usually hydrolyzed to silanols.

The hydrolyzate solution has only limited stability and is prone to undergoing condensation.

Silanols react with the reactive glass surface and form a bonding agent layer about 5 nm in thickness, which extends over the fiber surface like a protective veil. The protective veil, which at the initial oligomer stage is still soluble, later condenses to form crosslinked structures and at the end is present as a siloxane ≡Si—O—Si≡.

The sizings comprising bonding agents may contain, in addition to a primer, still other additions, for example antistats, emulsifiers, stabilizers and biocides, whereby specific effects are to be achieved. These further auxiliary components are commonly known and described for example in K. L. Löwenstein—The Manufacturing Technology of Continuous Glass Fibres, Elsevier Scientific Publishing Corp. Amsterdam—Oxford N.Y., 1983.

There are certain applications of glass fibers where the sizing, more particularly the textile-type sizing, has to be removed before the glass-fiber products are used in the composite. Desizing is realized through chemical and/or through thermal treatment. In the course of the process, the appropriate adhesion promoter is applied by a final treatment of the woven fabric.

The desizing operation, more particularly thermal desizing, impairs the fiber, hence the fabric strength and ultimately the strength of the composites produced therefrom. Immediately after desizing, the desized fabric is treated with the intended hydrolyzed silane solution or silanol (after hydrolysis).

The continuous finishing step takes place in a drenching bath directly after emergence from the desizing oven. Thereafter, the fabric is dried and wound up. The pure polysiloxane layer which is present on the glass fiber surface at the end often endows the fabric with a certain stiffness which can lead to the filaments being damaged during further processing.

The desizing operation and also the application of the finishing solution impair operational effectivity and contribute to elevating the manufacturing costs.

It is an object of the present invention to provide a spin finish which is particularly suitable for R-, E-, ECR- and S-glass fibers and has good chemical stability and which distinctly improves the treatment of above recited glass fibers and their physical-chemical properties. The spin finish shall make it possible to dispense with the desizing step and hence not to impair the fibers.

The chemically stable spin finish of the present invention should endow the weave roving with good processing properties (integrity, cuttability, lubricity, slip resistance).

The woven fabric produced from the roving shall combine a satisfactory hand, i.e., the fibers shall not be blunt nor brittle and be approximately semisoft, with good penetration ability, i.e., have migration of resins between individual filaments, for polymer resins, such as polyester or epoxy resins for example. The composites fabricated from the fabric shall have significantly better mechanical properties, especially with regard to strength (tensile strength, compressive strength, flexural strength and impact-flexural strength), compared with the desized fabric.

We have found that this object is achieved by an aqueous sizing (an aqueous spin finish) as per the features of claim 1.

It is essential to the present invention that an aqueous sizing, in addition to water and CH₃COOH, consists exclusively of a wetting agent, the wetting agent quantity in the composition being below 0.0015% by mass, a two-component film former and a one- or two-component adhesion promoter.

The treatment of R-, E-, ECR- and S-glass fibers with this aqueous sizing (aqueous spin finish) has the effect that despite the absence of hitherto typical sizing components, such as a lubricant or a wetting agent, the glass fibers and the overall thread (fiber bundle) are endowed with good processing properties during their production and also later processing.

It has been determined that, surprisingly, the aqueous sizing of the present invention ensures good lubricity and satisfactory slippage resistance for the warp and weft threads in the weaving operation. This is reflected particularly in the strength of the woven fabric and of the composites produced therefrom.

It must further be noted that the aqueous spin finish of the present invention requires only film formers and an adhesion promoter as essential constituents, and makes it possible to dispense with the desizing step, which has an adverse effect on the fibers.

This is a contribution to simplification and efficient working in further processing of glass fibers (process).

Subclaims 2 to 8 show advantageous embodiments of the aqueous sizing (aqueous spin finish) of the present invention without describing the latter conclusively.

It was determined in numerous conducted experiments and tests that the glass fiber and glass fiber bundle properties required and necessary for the purposes of the present invention are particularly achieved when the glass fibers are coated with aqueous spin finish of the following chemical composition:

| | | |
|---|---|---|
| 1. | CH₃COOH (60%) | 0.15-0.30% by mass |
| 2. | Polyvinyl alcohol polyether | 0.03-0.10% by mass |
| | and/or polyvinylpyrrolidone | |
| 3. | Aminosilane or methacryloylsilane | 0.30-0.80% by mass |
| | and/or epoxysilane | |
| 4. | Water as balance to 100% by mass of | |
| | the aqueous spin finish. | |

It will be found particularly advantageous to introduce the silane adhesion promoter into the aqueous spin finish as γ-aminopropyltriethoxysilane, as a γ-methacryloyloxypropyltrimethoxysilane or as a γ-glycidyloxypropyltrimethoxysilane.

These coupling agents are generally known as primers. Acetic acid is added to the aqueous spin finish to set the desired pH.

It will be found particularly advantageous for the spin finish, i.e., the water-free fractions of the aqueous spin finish, to contain 8.0% to 12.0% by mass of the film former and 88% to 92% by mass of the bonding agent, converted to solids concentration. At these component quantities and at this quantity ratio, all the abovementioned positive properties of the spin finish (sizing) of the present invention and of the fibers produced therewith are particularly well established.

It is further preferable for the wetting agent quantity to be in the range from 0.00001% by mass to 0.0015% by mass of the sizing.

The present invention process for treating the fibers with the present invention aqueous spin finish is effected by applying the latter to the glass fiber surface, removing the excess sizing and thermally treating the coated glass fibers.

The aqueous spin finish of the present invention is applied using spray nozzles or by means of a godet (applicator). The excess sizing is removed and the coated fibers are dried in the course of a thermal treatment.

Excess sizing for the purposes of the present invention is the amount of spin finish which is not taken up by the individual filaments and is flung off during winding.

It will be found particularly advantageous to carry out the thermal treatment in the temperature range from 100° C. to 150° C. This drying takes place in a high-frequency dryer, in an electrically heated, conventional chamber dryer and/or in a microwave dryer. It has emerged that the water-free spin finish fraction is 0.3% to 1.0% by mass based on the fibers. The present invention will be more particularly described with reference to the examples which follow. The origin of the components used is reported between parentheses in each case.

This object of the invention is also achieved by a fiber coated with an aqueous sizing according to any one of claims 1 to 8 and by a process according to claim 10 or 11.

The invention further relates to the roving or glass staple fibers coated with the spin finish described above and also to products produced therefrom, for example wovens, scrims, glass fiber mats, nonwoven glass fiber webs and the like.

### EXAMPLE 1

### Production of Inventive Aqueous Spin Finish PF34

### Composition:

| | | |
|---|---|---|
| 1. | CH₃COOH (60%) | 0.20% by mass |
| 2. | PVP K90 polyvinylpyrrolidone (20%) | 0.10% by mass |
| 3. | Polyvinyl alcohol polyether (20%) | 0.10% by mass |
| 4. | γ-Methacryloyloxypropyltrimethoxysilane | 0.30% by mass |
| 5. | Water | 99.20% by mass |

### 100 kg of Sizing Contains:

| | | |
|---|---|---|
| 1. | CH₃COOH (60%) | 0.20 kg |
| 2. | PVP K90 polyvinylpyrrolidone (20%) | 0.10 kg |
| 3. | Polyvinyl alcohol polyether (20%) | 0.10 kg |
| 4. | γ-Methacryloyloxypropyltrimethoxysilane | 0.30 kg |
| 5. | Water | 99.20 kg |

### Procedure—100 kg Mixing Operation:

1. 85.0 kg of water are initially charged+0.18 kg of CH₃COOH (60%) are initially charged.
2. 0.3 kg of γ-methacryloyloxypropyltrimethoxysilane (A 174)+20 g of CH₃COOH (60%) are hydrolyzed with 3.5 kg of hot deionized water.
3. Addition of the hydrolyzate solution.
4. 0.10 kg of PVP K90 polyvinylpyrrolidone dissolved in 2 kg of hot water is added to the batch.
5. 0.10 kg of polyvinyl alcohol polyether (Arkofil CS20-20%) is added to the batch.
6. Addition of the remaining water quantity (8.8 kg)+about 1 g of a wetting agent (Surfynol 440).
7. Stirring the spin finish and pH determination.

Solids composition:

| | | |
|---|---|---|
| 1. | Polyvinylpyrrolidone | 5.9% by mass |
| 2. | Polyvinyl alcohol polyether | 5.9% by mass |
| 3. | Methacryloylsilane | 88.2% by mass |

Solids concentration: Fₖ = 0.34% by mass

### EXAMPLE 2

### Production of Inventive Aqueous Spin Finish PF35

### Composition:

| | | |
|---|---|---|
| 1. | CH₃COOH (60%) | 0.20% by mass |
| 2. | PVP K90 polyvinylpyrrolidone (20%) | 0.12% by mass |
| 3. | Polyvinyl alcohol polyether (20%) | 0.12% by mass |
| 4. | γ-Methacryloyloxypropyltrimethoxysilane | 0.20% by mass |
| 5. | γ-Glycidyloxypropyltrimethoxysilane^{(5,6)} | 0.20% by mass |
| 6. | Water | 99.16% by mass |

### 100 kg of Sizing Contains:

| | | |
|---|---|---|
| 1. | CH₃COOH (60%) | 0.20 kg |
| 2. | PVP K90 polyvinylpyrrolidone (20%) | 0.12 kg |
| 3. | Polyvinyl alcohol polyether (20%) | 0.12 kg |
| 4. | γ-Methacryloyloxypropyltrimethoxysilane | 0.20 kg |
| 5. | γ-Glycidyloxypropyltrimethoxysilane | 0.20 kg |
| 6. | Water | 99.16 kg |

### Procedure—100 kg Mixing Operation:

1. 85.0 kg of water are initially charged+0.17 kg of CH₃COOH (60%) are initially charged.
2. 0.2 kg of γ-methacryloyloxypropyltrimethoxysilane (A 174)+0.2 kg of γ-glycidyloxypropyltrimethoxysilane are admixed with 30 g of CH₃COOH (60%) and hydrolyzed with 3.5 kg of hot deionized water.
3. Addition of the hydrolyzate solution.
4. 0.12 kg of PVP K90 polyvinylpyrrolidone dissolved in 2 kg of hot water is added to the batch.
5. 0.12 kg of polyvinyl alcohol polyether (Arkofil CS20-20%) is added to the batch.
6. Addition of the remaining water quantity (8.76 kg)+about 1 g of a wetting agent (Surfynol 440).
7. Stirring the sizing and pH determination.

Solids composition:

| | | |
|---|---|---|
| 1. | Polyvinylpyrrolidone | 5.4% by mass |
| 2. | Polyvinyl alcohol polyether | 5.4% by mass |
| 3. | Methacryloylsilane | 44.6% by mass |
| 4. | Epoxysilane | 44.6% by mass |

Solids concentration: Fₖ = 0.45% by mass

### EXAMPLE 3

### Production of Inventive Aqueous Spin Finish PF36

### Composition:

| | | |
|---|---|---|
| 1. | CH₃COOH (60%) | 0.20% by mass |
| 2. | PVP K90 polyvinylpyrrolidone (20%) | 0.12% by mass |
| 3. | Polyvinyl alcohol polyether (20%) | 0.12% by mass |
| 4. | γ-Glycidyloxypropyltrimethoxysilane | 0.40% by mass |
| 5. | Water | 99.16% by mass |

### 100 kg of Sizing Contains:

| | | |
|---|---|---|
| 1. | CH₃COOH (60%) | 0.20 kg |
| 2. | PVP K90 polyvinylpyrrolidone (20%) | 0.12 kg |
| 3. | Polyvinyl alcohol polyether (20%) | 0.12 kg |
| 4. | γ-Glycidyloxypropyltrimethoxysilane | 0.40 kg |
| 5. | Water | 99.16 kg |

### Procedure—100 kg Mixing Operation:

1. 85.0 kg of water are initially charged+0.17 kg of CH₃COOH (60%) are initially charged.
2. 0.4 kg of γ-glycidyloxypropyltrimethoxysilane+30 g of CH₃COOH (60%) are hydrolyzed with 3.5 kg of hot deionized water.
3. Addition of the hydrolyzate solution.
4. 0.12 kg of PVP K90 polyvinylpyrrolidone dissolved in 2 kg of hot water is added to the batch.
5. 0.12 kg of polyvinyl alcohol polyether (Arkofil CS20-20%) is added to the batch.
6. Addition of the remaining water quantity (8.76 kg)+about 1 g of a wetting agent (Surfynol 440).
7. Stirring the spin finish and pH determination.

Solids composition:

| | | |
|---|---|---|
| 1. | Polyvinylpyrrolidone | 5.4% by mass |
| 2. | Polyvinyl alcohol polyether | 5.4% by mass |
| 3. | Epoxysilane | 89.2% by mass |

Solids concentration: Fₖ = 0.45% by mass

1-14. (canceled)

15. An aqueous sizing for treating R-glass fibers, E-glass fibers, ECR-glass fibers and S-glass fibers, the aqueous sizing comprising:
water;
CH₃COOH;
a wetting agent, said wetting agent quantity being below 0.0015% by mass;
a two-component film former; and
an adhesion promoter selected from the group consisting of a one-component adhesion promoter and a two-component adhesion promoter.

16. The aqueous sizing according to claim 15, wherein said two-component film former consists of at least one of a polyvinyl alcohol polyether and a polyvinylpyrrolidone.

17. The aqueous sizing according to claim 16, wherein said adhesion promoter is a silane adhesion promoter.

18. The aqueous sizing according to claim 15, wherein said adhesion promoter is one two silane adhesion promoters.

19. The sizing according to claim 16, wherein:
said CH₃COOH is CH₃COOH (60%) and is 0.15-0.30% by mass;
said polyvinyl alcohol polyether and/or said polyvinylpyrrolidone are 0.03-0.10% by mass;
said silane adhesion promoter is selected from the group consisting of aminosilane, methacryloylsilane, and epoxysilane and is 0.30-0.80% by mass;
remainder said water.

20. The aqueous sizing according to claim 19, wherein said silane adhesion promoter is selected from the group consisting of a γ-methacryloyloxypropyltrimethoxysilane, a γ-aminopropyltriethoxysilane, and a γ-glycidyloxypropyltrimethoxysilane, which are hydrolyzable to silanols.

21. The aqueous sizing according to claim 15, wherein based on a solids concentration of the aqueous sizing:
said two-component film former is 8.0% to 12.0% by mass; and
said adhesion promoter is 88% to 92% by mass, a sum total of said two-component film former and said adhesion promoter always adding up to 100% by mass.

22. The aqueous sizing according to claim 15, wherein said wetting agent quantity is in a range from 0.00001% by mass to 0.0015% by mass of the sizing.

23. A method of treating glass fibers selected from the group consisting of R-glass fibers, E-glass fibers, ECR-glass fibers and S-glass fibers for one of roving and glass staple fiber production, which comprises the steps of:
treating the glass fibers with an aqueous sizing containing water, CH₃COOH, a wetting agent having a quantity being below 0.0015% by mass, a two-component film former, and an adhesion promoter selected from the group consisting of a one-component adhesion promoter and a two-component adhesion promoter.

24. A process for treating R-glass fibers, E-glass fibers, ECR-glass fibers and S-glass fibers with an aqueous sizing containing water, CH₃COOH, a wetting agent having a quantity being below 0.0015% by mass, a two-component film former, and an adhesion promoter selected from the group consisting of a one-component adhesion promoter and a two-component adhesion promoter, which comprises the step of:
applying the aqueous sizing to a glass fiber surface resulting in a coated glass fiber surface;
removing excess aqueous sizing; and
thermally treating the coated glass fiber surface.

25. The process according to claim 24, which further comprises applying the aqueous sizing using one of spray nozzles and by means of an applicator.

26. A fiber configuration, comprising:
glass fibers selected from the group consisting of R-glass, E-glass, ECR-glass, S-glass and glass fiber products all coated with an aqueous sizing, the aqueous sizing containing:
water;
CH₃COOH;
a wetting agent, said wetting agent quantity being below 0.0015% by mass;
a two-component film former; and
an adhesion promoter selected from the group consisting of a one-component adhesion promoter and a two-component adhesion promoter.

27. The fiber configuration according to claim 26, wherein a spin finish content is 0.3% to 1.2% by mass as solids based on said glass fibers.

28. The fiber configuration according to claim 26, wherein said glass fibers are formed as one of wovens, scrims, glass fiber mats and nonwoven glass fiber webs.
